(19) United States
(12) Patent Application Publication
(10) Pub. No.: US 2006/0155494 A1
(43) Pub. Date: Jul. 13, 2006

(54) Event-quantity measuring instrument and pedometer

(76) Inventors: Kazuo Kato, Chiba-shi (JP); Yoshinori Sugai, Chiba-shi (JP)

Correspondence Address: BRUCE L. ADAMS, ESQ.;SUITE 1231, 17 BATTERY PLACE, NEW YORK, NY, 10004, US

(21) Appl. No.: 11/326,143

(22) Filed: Jan. 5, 2006

(30) Foreign Application Priority Data
Jan. 7, 2005 (JP) 2005-002711
Dec. 15, 2005 (JP) 2005-361529

(51) Int. Cl. G06F 19/00

(52) U.S. Cl. 702/81

(57) ABSTRACT

To provide a portable event-quantity measuring instrument which makes it possible to hold event-quantity data significantly and in a form of suppressing a storage area to the minimum. A portable event-quantity measuring instrument includes an event detection unit which senses an event and outputs an event signal; event-quantity counting means for counting the event signal and counting an event quantity, the event-quantity counting means including daily event-quantity counter units each of which daily counts the event quantity, and absolute weekly event-quantity counter units each of which counts the event quantity every absolute week from a specific day of a week until a day before the day concerned of the next week; and event-quantity storing means for readably storing the counted event quantity, the event-quantity storing means including daily event-quantity storage units each of which stores event quantities over plural days, and absolute weekly event-quantity storage units each of which stores event quantities over plural absolute weeks.

### BACKGROUND OF THE INVENTION

1. Field of the Invention

The present invention relates to a portable event-quantity measuring instrument such as a pedometer for measuring a quantity of events such as walking in a form of a quantity of events such as the number of steps.

2. Description of the Prior Art

Since a portable event-quantity measuring instrument such as a pedometer has limitations on a storage capacity, it has been practically difficult to store long-period data on the number of steps so as to make it possible to be referred to though it has been possible to store daily data on the number of steps so as to make it possible to be referred to. It is desired to store such number-of-step data (event-quantity data) efficiently.

For example, proposals as described below have been made. One proposal is that, in the case of measuring/storing the daily number-of-step data, it is made possible to set a starting point of a day not at zero o'clock in the morning but at an arbitrary time corresponding to a daily life pattern of a user, thereby measuring/storing the number-of-step data in a significant unit (JP 2003-99754 A). Another proposal is that, in the case where the number of steps per day is a predetermined quantity or less, the pedometer is regarded not to be used, and an average number of steps per day is obtained excluding this case (JP 2001-297318 A).

A further proposal is that, in the case of measuring/storing such measurement data as the number of steps, the data concerned is compressed, or compressed at two different types of degrees every time the number of data reaches a predetermined number, and the data is thus held in a state where the number thereof is not too large or not too small (for example, JP 09-79871 A).

Note that to measure, and accumulate/record the event quantity per day and per week itself is known.

The present invention has been made in consideration of the above-described various points, and an object of the present invention to provide a portable event-quantity measuring instrument capable of holding the event-quantity data in a significant form for the user and in a form of suppressing a storage area to the minimum.

### SUMMARY OF THE INVENTION

In order to achieve the above object, a portable event-quantity measuring instrument of the present invention, includes: an event detection unit which senses an event and outputs an event signal; event-quantity counting means for counting the event signal outputted from the event detection unit and counting an event quantity, the event-quantity counting means including a daily event-quantity counter unit which daily counts the event quantity, and an absolute weekly event-quantity counter unit which counts the event quantity every absolute week defined from a specific day of a week until a day before the specific day of the next week; and event-quantity storing means for readably storing the counted event quantity, the event-quantity storing means including a daily event-quantity storage unit which stores daily event quantities over plural days, and an absolute weekly event-quantity storage unit which stores absolute weekly event quantities over plural absolute weeks.

In the portable event-quantity measuring instrument of the present invention, there is provided the “event-quantity storing means for readably storing the counted event quantity, the event-quantity storing means including a daily event-quantity storage unit which stores daily event quantities over plural days, and a weekly event-quantity storage unit which stores weekly event quantities over plural weeks”. Accordingly, even if there are limitations on the storage capacity because the measuring instrument is a portable device, the event quantity can be recorded/referred to in detail in a state where the storage area is suppressed to the minimum. Further, in the portable event-quantity measuring instrument of the present invention, the weekly counting/storing of the event quantity is performed every absolute week defined from a specific day of a week until a day before the specific day of the next week. Accordingly, in a state where many weeks have elapsed since the measurement was started, a measurement result can be read out/referred to without actually depending on the day when the measurement of the event quantity was started. Therefore, the measurement result of the event quantity is easy to understand.

Here, typically, the daily event-quantity storage unit has an area for approximately one week (approximately seven days). In such a way, though it becomes impossible to refer to daily data before a period of seven days, the data before the period of seven days is stored as the absolute weekly data, and accordingly, it is also possible to refer to such old data. However, a storage period of the daily data in the daily event-quantity storage unit may be shorter than seven days or longer than seven days if desired.

In the portable event-quantity measuring instrument of the present invention, the absolute weekly event-quantity counter unit may be configured so as to accumulate the event quantities stored in the daily event-quantity storage unit every absolute week. However, typically, not only the daily event-quantity counter unit is configured so as to count a number of the event signals outputted from the event detection unit, and to daily count the event quantities, but also the absolute weekly event-quantity counter unit is configured so as to count the number of event signals outputted from the event detection unit, and to count the event quantities every absolute week.

In this case, in the case of counting the event signals outputted from the event detection unit, not only the daily event quantities but also the absolute weekly event quantities can be directly obtained. Accordingly, the stored data is displayed without performing an arithmetic operation in the case of referring to the recent absolute weekly event quantities, thus making it possible to notify of the event quantities immediately. Specifically, a time required for the display is suppressed to the minimum, thus making it possible to avoid a standby state for the display. When a creation interval of the events is approximately 0.2 to 0.3 or more, a time between the creations is effectively utilized, and an up-to-date state is always stored. Further, in this case, it is possible to simplify/uniformalize the arithmetic operation, and accordingly, it is possible to suppress a size of a processing program to the minimum.

Typically, the portable event-quantity measuring instrument of the present invention is worn on the wrist, like a wrist watch. However, other wearable forms may be adopted, such as being put on the waist, in response to a type of the events to be measured. Depending on the case, in place of directly putting the measuring instrument on the body, the measuring instrument may be housed and carried in a baggage such as a bag.

Typically, the portable event-quantity measuring instrument of the present invention is configured by a pedometer in which the event is walking, the event signal is a walking signal, and the event quantity includes at least one quantity selected from the group consisting of a number of steps, a calorie consumption, a walking distance, and a walking time. However, the portable event-quantity measuring instrument may also be configured so as to measure another quantity such as an average walking speed (=(walking distance)/(walking time)). Further, the portable event-quantity measuring instrument may also be configured to measure, as the event, a quantity of another exercise than the walking, and the like. Further, the portable event-quantity measuring instrument may also be configured to measure another quantity such as a pulsation (heart beat) simultaneously.

In the case where the portable event-quantity measuring instrument of the present invention is configured by the pedometer, the pedometer of the present invention includes: a walking sensor which senses walking and outputs a walking signal; number-of-step counting means for counting a number of the walking signals from the walking sensor and counting a number of steps, the number-of-step counting means including a daily number-of-step counter unit which daily counts the number of steps, and an absolute weekly number-of-step counter unit which counts the number of steps every absolute week defined from a specific day of a week until a day before the specific day of the next week; and number-of-step storing means for readably storing the counted number of steps, the number-of-step storing means including a daily number-of-step storage unit which stores a daily number of steps over plural days, and an absolute weekly number-of-step storage unit which stores an absolute weekly number of steps over plural absolute weeks.

Typically, in the pedometer of the present invention, the daily number-of-step counter unit is configured to count a number of the walking signals from the walking sensor, and to daily count the number of steps, and the absolute weekly number-of-step counter unit is configured to count the number of walking signals from the walking sensor, and to count the number of steps every absolute week.

### BRIEF DESCRIPTION OF THE SEVERAL VIEWS OF THE DRAWINGS

A preferred form of the present invention is illustrated in the accompanying drawings in which:

FIG. 1 is a block diagram showing an outline of a hardware configuration of a pedometer in a preferred embodiment according to the present invention;

FIG. 2 are outlines of a data structure of the pedometer of FIG. 1, in which part FIG. 2A is an explanatory view of a configuration of timepiece data, part FIG. 2B is an explanatory view of a configuration of daily data, and part FIG. 2C is an explanatory view of a configuration of absolute weekly data;

FIG. 3 is a flowchart showing a flow of counting processing for data relating to walking, which is performed every step in the pedometer of FIG. 1;

FIG. 4 is a flowchart showing a flow of update processing for a day and an absolute week performed in the pedometer of FIG. 1;

FIG. 5 is an explanatory view of switching among various modes in the pedometer of FIG. 1;

FIG. 6 is a planar explanatory view of outlines of an exterior appearance and display unit of the pedometer of FIG. 1;

FIG. 7 is a block diagram showing functions of the pedometer of FIG. 1.

### DETAILED DESCRIPTION OF THE PREFERRED EMBODIMENTS

Next, a description will be made on a preferred example shown in the accompanying drawings according to a preferred embodiment of the present invention.

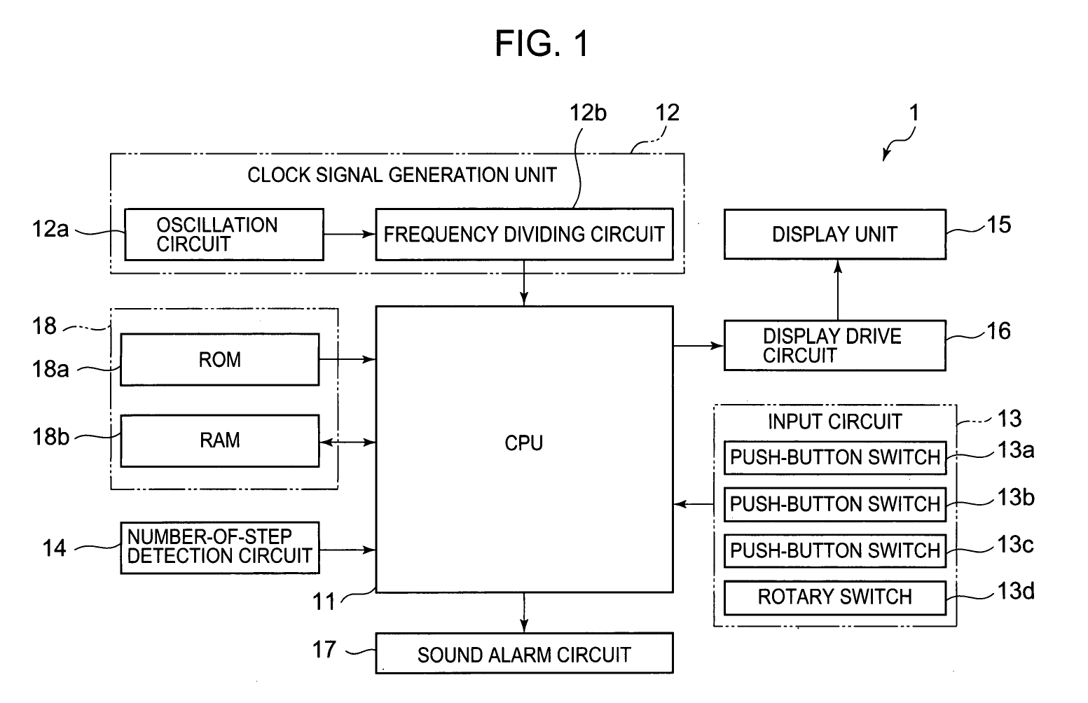

FIG. 1 to FIG. 7 show a wrist-wearable pedometer, as a portable event-quantity measuring instrument of the preferred embodiment according to the present invention.

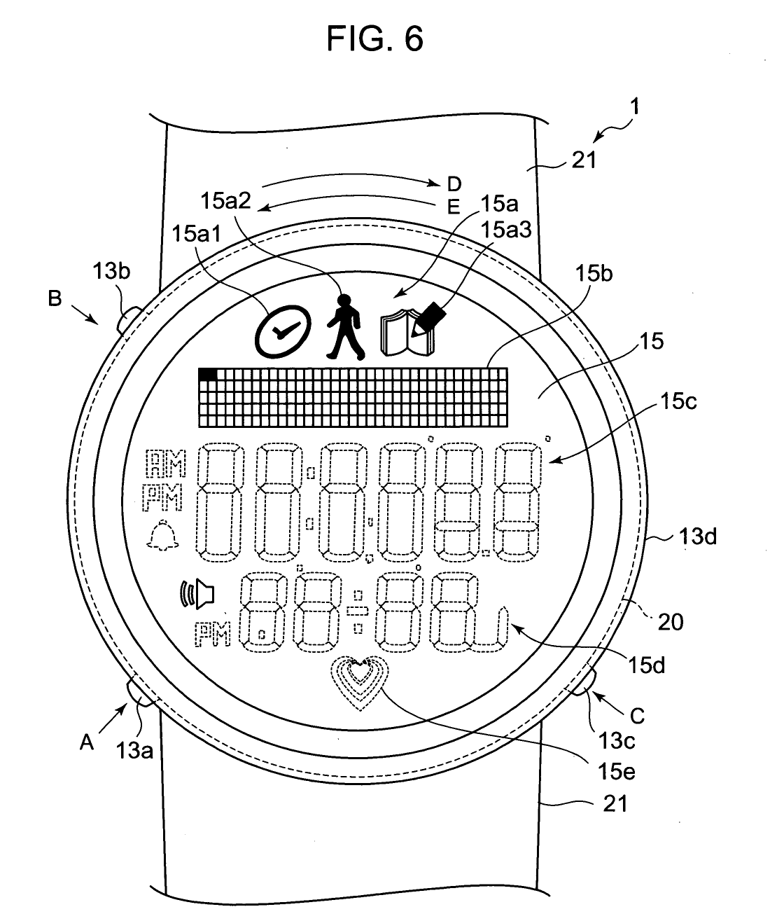

FIG. 1 is a block diagram showing a hardware configuration of such an wrist-wearable pedometer 1 of a first preferred embodiment according to the present invention, and FIG. 6 is an explanatory view of an exterior appearance of the wrist-wearable pedometer 1. In FIG. 1 or FIG. 6, the pedometer 1 includes: a central processing unit (CPU) 11; a clock signal generation unit 12 including an oscillation circuit 12a which outputs a signal of a predetermined frequency, and a frequency dividing circuit 12b which divides a frequency of a clock pulse from the oscillation circuit 12a in a predetermined frequency dividing ratio and outputs a clock signal (a reference signal for timekeeping); an input unit 13 composed of three push-button switches 13a, 13b, and 13c, and of a rotary switch 13d; a walking sensor or a walking detection circuit 14 which detects walking and outputs a walking signal F corresponding to the walking; a display unit 15 such as a liquid crystal display unit on which displayed are the number of steps, a time, and the like, and a display drive circuit 16 which controls the display on the display unit; an sound alarm circuit 17 which gives an alarm and the like in a specific case; a read only memory (ROM) 18a which pre stores a program and the like to be executed by the CPU 11; an erasable random access memory (RAM) 18b which offers a work area of the program and stores data on the number of steps measured, data on a walking distance measured, set values, and the like. The ROM 18a and the RAM 18b configure a storage unit 18 for the CPU 11.

Note that, as shown in FIG. 6, the wrist-wearable pedometer 11 takes a form of a wrist watch, which includes a case 20 having the display unit 15 located on a center opening thereof, and a band 21. The rotary switch 13d in a form of an operation ring is rotatable in D and E directions with respect to a body of the case 20, and the push-button switches 13a, 13b and 13c in a form of a push button, located at the upper left, lower left and lower right respectively, slightly protrude from a peripheral wall of the body of the case 20, and are capable of being depressed in A, B and C directions, respectively. In the following description regarding the embodiment, types, number, and roles of the switches 13 may be changed to arbitrary modes different from those of this embodiment.

The walking sensor 14 disposed in the case 20 may be of any type such as a pendulum type, a ball type, an acceleration sensing type, and others. The pedometer may further include a pulsation sensor.

The pedometer 1 has storage areas for time data TD, daily data DD, and absolute weekly data WD in the RAM 18b.

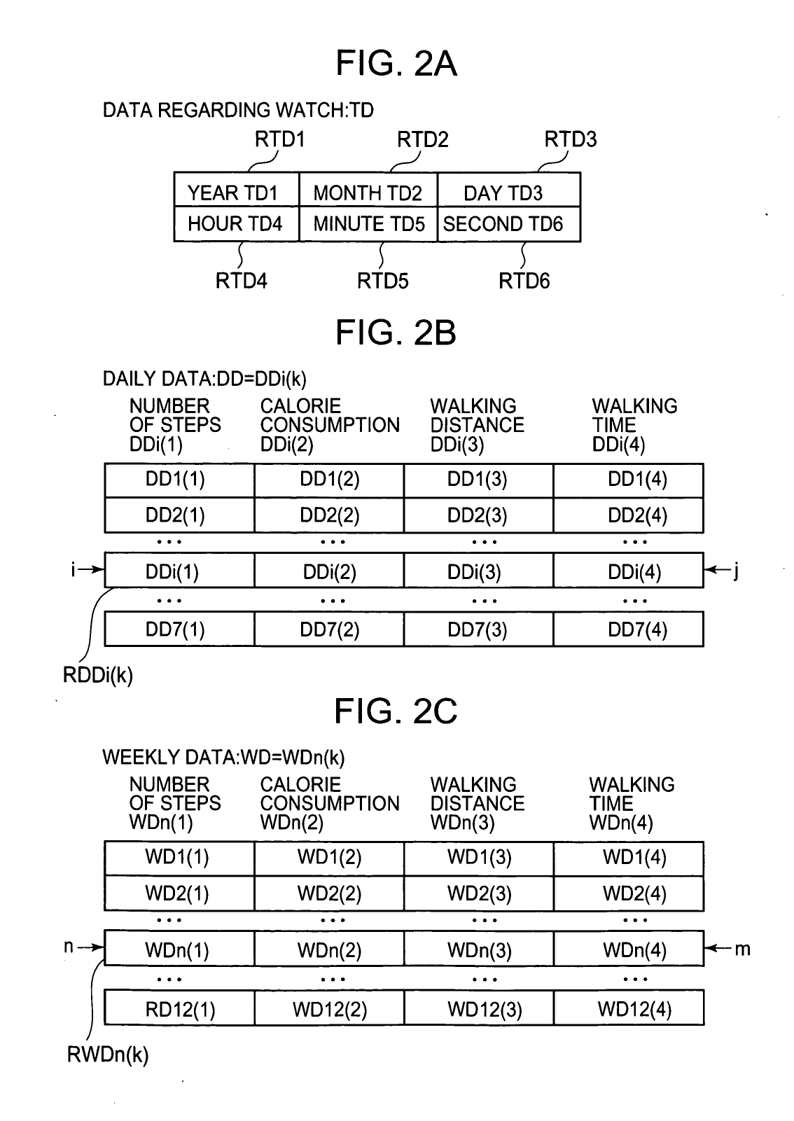

As shown in FIG. 2A, the time data TD is composed of year data TD1, month data TD2, day data TD3, hour data TD4, minute data TD5, and second data TD6. These data TD1, TD2, TD3, TD4, TD5, and TD6 are stored in storage areas RTD1, RTD2, RTD3, RTD4, RTD5, and RTD6 in the RAM 18b, respectively.

Of the timepiece data TD, the second data TD6 is updated by the clock signal from the clock signal generation unit 12 every time interruption processing of 1 Hz is performed therefor. In this case, based on a current time, the minute data TD5, the hour data TD4, the day data TD3, the month data TD2, and the year data TD1 are updated.

As shown in FIG. 2B, the daily data DD is composed of the daily number of steps DDi(1), a daily calorie consumption per day DDi(2), a daily walking distance DDi(3), and a daily walking time daily DDi(4), each of which includes data of seven days. In general, the daily data DD is composed of a data group represented by DDi(k). The value k is set to one of integers of 1 to 4, and k=1 represents the number of steps; k=2 the calorie consumption; k=3 the walking distance; and k=4 the walking time. The value i is set to one of integers of 1 to 7. When i=1 represents data of the current day, i=2 represents data of six days before, i=3 represents data of five days before, i=4 represents data of four days before, i=5 represents data of three days before, i=6 represents data of two days before, i=7 represents data of one day before. Specifically, when i=1 represents data of the current day, for example, the number-of-step data of two days before is k=1 and i=6, with which the data is represented by DD6(1).

The daily data DD, that is, DDi(k) is stored in a respective daily data storage area RDDi(k) for each thereof in the RAM 18b. Here, meanings of i and k are as described above. The address of the RAM 18b can be designated by using i and k for modifying the address on the program.

In a similar way, as shown in FIG. 2C, the absolute weekly data WD is composed of the absolute weekly number of steps WDn(1), an absolute weekly calorie consumption WDn(2), an absolute weekly walking distance WDn(3), and an absolute weekly walking time WDn(4), each of which includes data of absolute twelve weeks. In general, the absolute weekly data WD is composed of a data group represented by WDn(k). The value k is set to one of integers of 1 to 4, and similarly to the case of the daily data, k=1 represents the number of steps; k=2 represents the calorie consumption; k=3 the walking distance; and k=4 the walking time. The value n is set to one of integers of 1 to 12. When n=1 represents data of an absolute week including the current day, n=2 represents data of eleven absolute weeks before, n=3 represents data of ten absolute weeks before, . . . , n=11 represents two absolute weeks before, and n=12 represents data of the last week. Specifically, for example, the number-of-step data of two weeks before is n=11 and k=1, with which the data is represented by WD11(1).

The absolute weekly data WD, that is, WDn(k) is stored in an absolute weekly data storage area RWDn(k) for each thereof in the RAM 18b. Here, meanings of n and k are as described above. Also in this case, the address of the RAM 18b can be designated by using n and k for modifying the address on the program.

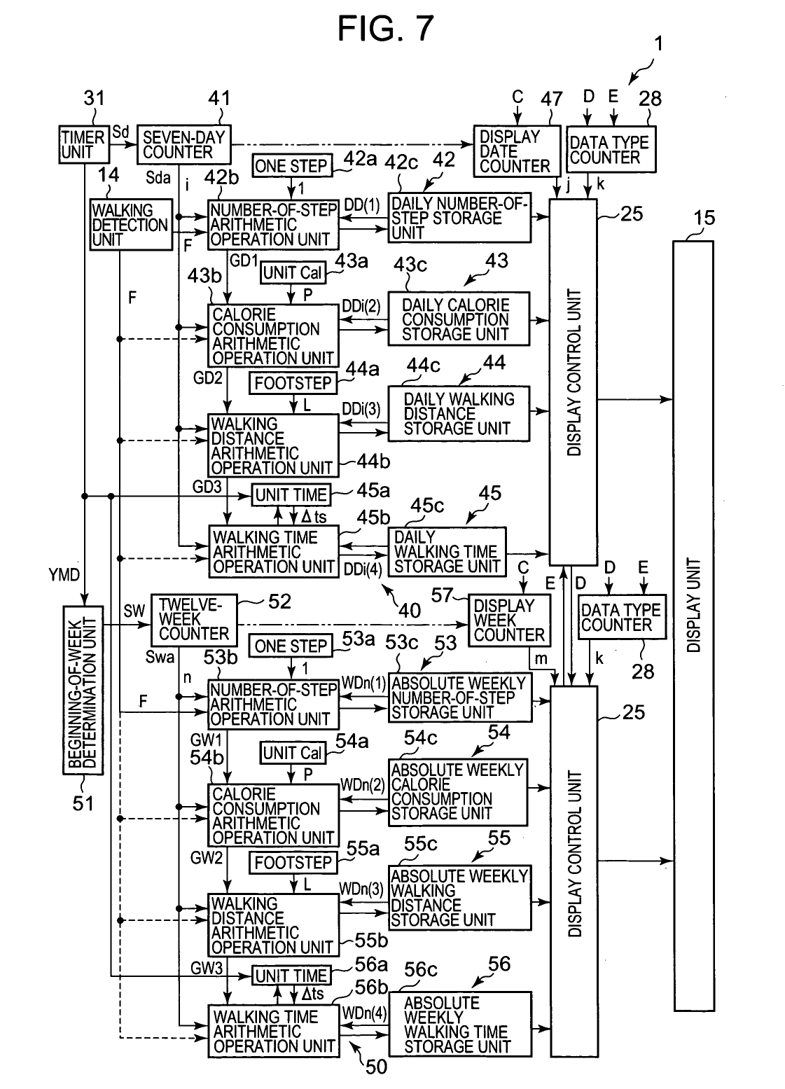

FIG. 7 is a functional block diagram of the pedometer 1 composed of the hardware configuration shown in FIG. 1. The respective functional elements configuring this functional block diagram are basically-composed of the CPU 11, and the program stored in the ROM 18a and executed by the CPU 11. This functional block diagram is a mere example, and as long as the input and the display are realized similarly, a way of processing is changeable, and hence, the functional block diagram is also changeable.

As understood from FIG. 7, the pedometer 1 includes a timer unit 31, the walking detection unit 14, a daily data processing unit 40, and an absolute weekly data processing unit 50. The walking detection unit 14 generates a walking pulse F every time it detects the walking, and more specifically, every time the user of the pedometer 1 walks one step.

The daily data processing unit 40 includes a daily number-of-step processing unit 42, a daily calorie consumption processing unit 43, a daily walking distance processing unit 44, a daily walking time processing unit 45, and the display control unit 25, and the display unit 15, in addition to a seven-day counter 41. When the display is also taken into consideration, the daily data processing unit 40 further includes a display date counter 47, and a data type counter 28, which will be described later.

For example, the seven-day counter 41 is a counter in which a counter value i is changed cyclically from 1 to 7. Every time it reaches 24 o'clock, the counter 41 receives a change-of-day signal Sd from the time unit 31, and changes the counter value i by one. The contents 1, 2, 3, 4, 5, 6, and 7 of the counter 41 represent continuous seven days, respectively. Note that, every time of receiving the change-of-day signal Sd, the seven-day counter 41 issues a change-of-day alarm signal Sda. In the case of program processing, the change-of-day alarm signal Sda may be replaced by arbitrary information indicating that change-of-day processing (24-hour interruption processing) has been completed.

The daily number-of-step processing 42 includes a one-step walking data holding unit 42a, a number-of-step arithmetic operation unit 42b, and a daily number-of-step storage unit 42c. The one-step walking data holding unit 42a holds data “1” which represents one step.

The daily number-of-step storage unit 42c holds the daily number of steps DDi(1) for seven days in a daily number-of-steps storage area RDDi(1). Every time of receiving the walking pulse F from the walking detection unit 14, the number-of-step arithmetic operation unit 42b reads out the daily number of steps DDi(1) from the daily number-of-step storage area RDDi(1) corresponding to the contents i of the seven-day counter 41. Then, the number-of-step arithmetic operation unit 42b adds the held data “1” of the one-step walking data holding unit 42a to the daily number of steps DDi(1) to update the daily number of steps DDi(1), and overwrites and stores, in the daily number-of-step storage area RDDi(1), the daily number of steps DDi(1) thus updated. Further, the daily number-of-step storage unit 42c issues a daily number-of-step arithmetic operation completion signal GD1. Note that, upon receiving the change-of-day alarm signal Sda from the seven-day counter 41, the daily number-of-step processing unit 42 resets, to zero, the daily number of steps DDi(1) of the daily number-of-step storage area RDDi(1) corresponding to the contents i of the counter 41 at that time, thereby clearing, when the measurement period exceeds seven days, data of seven days before. Then, the daily number-of-step processing unit 42 resumes the count.

The processing of the number-of-step arithmetic operation unit 42b may also include increasing the counter value by “1” every time of receiving the walking signal F in place of receiving and adding “1” from the one-step walking data holding unit 42a every time of receiving the walking signal F. In this case, the one-step walking data holding unit 42a is unnecessary.

In a similar way, the daily calorie consumption processing unit 43 includes a unit calorie consumption holding unit 43a, a calorie consumption arithmetic operation unit 43b, and a daily calorie consumption storage unit 43c. The unit calorie consumption holding unit 43a holds a calorie consumption P per step.

The daily calorie consumption storage unit 43c holds a daily calorie consumption DDi(2) for seven days in a daily calorie consumption storage area RDDi(2). Every time of receiving the daily number-of-step arithmetic operation completion signal GD1 from the number-of-step arithmetic operation unit 42b, the daily calorie consumption arithmetic operation unit 43b reads out the daily calorie consumption DDi(2) from the daily calorie consumption storage area RDDi(2) corresponding to the contents i of the seven-day counter 41. Then, the daily calorie consumption arithmetic operation unit 43b adds the unit calorie consumption P held in the unit daily calorie consumption data holding unit 44a to the daily calorie consumption DDi(2) to update the daily calorie consumption DDi(2), and overwrites and stores, in the daily calorie consumption time storage are a RDDi(2), the daily calorie consumption DDi(2) thus updated. The daily calorie consumption arithmetic operation unit 43b then issues the daily calorie consumption arithmetic operation completion signal GD2. Note that, upon receiving the change-of-day alarm signal Sda from the seven-day counter 41, the daily calorie consumption processing unit 43 resets, to zero, the daily calorie consumption DDi(2) in the daily calorie consumption storage area RDDi(2) corresponding to the contents i of the counter 41 at that time.

The arithmetic processing in the calorie consumption arithmetic operation unit 43b may also be performed every time of receiving the walking pulse F from the walking detection unit 14 in place of the daily number-of-step arithmetic operation completion signal GD1 from the number-of-step arithmetic operation unit 42b. Further, the arithmetic operation of the calorie consumption may be performed by adding a calorie consumption per predetermined time (for example, ten seconds) every time of detecting the walking for the predetermined time in place of adding a calorie consumption of every step. For example, the unit calorie consumption is determined based on a gender, age, weight, walking speed and walking time (for example, ten seconds) of the user. For the gender, age, and weight of the user, data inputted as personal information in a personal data input mode Mk to be briefly described later is utilized. The walking speed can be calculated from the walking distance and the walking time, which are calculated here.

In a similar way, the daily walking distance processing unit 44 includes a stride length holding unit (stride length data holding unit) 44a, a walking distance arithmetic operation unit 44b, and a daily walking distance storage unit 44c. The stride length holding unit 44a holds a stride length (stride length data) L.

The daily walking distance storage unit 44c holds a daily walking distance DDi(3) for seven days in a daily walking distance storage area RDDi(3). Every time of receiving the daily calorie consumption arithmetic operation completion signal GD2 from the daily calorie consumption arithmetic operation unit 43b, the walking distance arithmetic operation unit 44b reads out the daily walking distance DDi(3) from the daily walking distance storage area RDDi(3) corresponding to the contents i of the seven-day counter 41. Then, the walking distance arithmetic operation unit 44b adds the stride length L held in the stride length holding unit 44a to the daily walking distance DDi(3) to update the daily walking distance DDi(3), and overwrites and stores, in the daily walking distance storage area RDDi(3), the daily walking distance DDi(3) thus updated. The walking distance arithmetic operation unit 44b then issues the daily walking distance arithmetic operation completion signal GD3. Note that, upon receiving the change-of-day alarm signal Sda from the seven-day counter 41, the daily walking distance processing unit 44 resets, to zero, the daily walking distance DDi(3) in the daily walking distance storage area RDDi(3) corresponding to the contents i of the counter 41 at that time. The arithmetic processing in the daily walking distance arithmetic operation unit 44b may also be performed every time of receiving the walking pulse F from the walking detection unit 14 in place of receiving the daily calorie consumption arithmetic operation completion signal GD2 from the daily calorie consumption arithmetic operation unit 43b.

In a similar way, the daily walking distance processing unit 45 includes a unit time data holding unit 45a, a walking distance arithmetic operation unit 45b, and a daily walking distance storage unit 45c. The unit time data holding unit 45a receives the time data from the timer unit 31. Every time of receiving the walking distance arithmetic operation signal GD3 or the walking pulse F, the walking time arithmetic operation unit 45b arithmetically operates an elapse time Δts since the walking time arithmetic operation unit 45b received the walking distance arithmetic operation completion signal GD3 or walking pulse F of one time, and determines whether or not the elapse time Δts is a predetermined time Δtss or less. When the time Δts is the predetermined time Δtss or less, the elapse time Δts is given as a unit turnaround time per step to the walking time arithmetic operation unit 45. Here, for example, Δtss is an upper limit of a time required for one step in the case of assuming that the walking is made as slow as possible. Note that, as mentioned in the calculation of the calorie consumption, for example, by taking approximately ten steps as a reference, the walking time may also be calculated on the basis of a time required for walking ten steps. Further, it may also be separately determined whether or not the walking is continuously made from a previous step, and when the walking is continuous, a walking time DD1(4) may be incremented by 1 every time one second elapses.

The daily walking time storage unit 45c holds a daily walking time DDi(4) for seven days in a daily walking time storage area RDDi(4). Every time of receiving the daily walking distance arithmetic operation completion signal GD3 from the walking distance arithmetic operation unit 44b, the walking time arithmetic operation unit 45b informs the unit walking time data holding unit 45a of reception of the signal GD3. Further, the walking time arithmetic operation unit 45b reads out the daily walking time DDi(4) from the daily walking time storage area RDDi(4) corresponding to the contents i of the seven-day counter 41, and adds the unit walking time data Δts from the unit walking time data holding unit 45a to the daily walking time DDi(4) to update the daily walking time DDi(4). The walking time arithmetic operation unit 45b then overwrites and stores, in the daily walking time storage area RDDi(4), the daily walking time DDi(4) thus updated. Note that, upon receiving the change-of-day alarm signal Sda from the seven-day counter 41, the daily walking time processing unit 45 resets, to zero, the daily walking time DDi(4) of the daily walking time storage area RDDi(4) corresponding to the contents i of the counter 41 at that time. The arithmetic processing in the daily walking time arithmetic operation unit 45 may also be performed every time of receiving the walking pulse F from the walking detection unit 14 in place of receiving the daily walking distance arithmetic operation completion signal GD 3 from the walking distance arithmetic operation unit 44b.

In the above, the daily number-of-step storage unit 42c, the daily calorie consumption storage unit 43c, the daily walking distance storage unit 44c, and the daily walking distance storage unit 45c configure constitute, as a whole, a storage unit RDDi(k) for a day data DDi(k) shown in FIG. 2B. The daily data can include other arbitrary data besides the above, for example, a daily average walking speed (=(daily walking distance)/(daily walking time)), and the like. Further, when the pedometer 1 includes a quantity measuring function other than the pedometer function and the timepiece function, for example, a pulsation measuring function, data relating to a pulsation (heart beat), data on an accumulation, average, maximum (highest), minimum (lowest) or the like of exercise intensity may be measured/stored daily and simultaneously.

Further, in the above, the signals GD1, GD2, GD3, and the like are ones for prompting the next processing. In the case of a program to be sequentially processed, the signals can be replaced by being defined as the next processing steps.

The absolute weekly data processing unit 50 is configured similarly to the daily data processing unit 40, except in performing the counting processing for the data every absolute week, that is, every week defined by days between a specific day of a week and a day before the specific day of the next week. Here, the absolute week is defined such that it starts on Monday and ends on Sunday. However, the absolute week may be defined such that starts on Sunday and ends on Saturday, or may be defined such that it starts on another arbitrary day of a week and ends on a day before the arbitrary day of the next week. Note that the absolute week defined as described above can be identified based on what number week of a month the absolute week is.

The absolute weekly data processing unit 50 includes an absolute weekly number-of-step processing unit 53, an absolute weekly calorie consumption processing unit 54, an absolute weekly walking distance processing unit 55, an absolute weekly walking time processing unit 56, a display control unit 25, and the display unit 15, in addition to a beginning-of-week determination unit 51 and a twelve-week counter 52. When the display is also taken into consideration, the absolute weekly data processing unit 50 further includes a display week counter 57, and a data type counter 28, which will be described later. The data type counter 28 for the daily data processing may be shared with the one for the absolute weekly data processing.

The beginning-of-week determination unit 51 determines the day of the week based on year/month/day information YMD of the timer unit 31, and issues a beginning-of-week signal Sw every time it reaches zero o'clock in the morning on the first day of the absolute week, here, Monday. The beginning-of-week signal Sw can include information as to what number week of the month the absolute week is.

For example, the twelve-week counter 52 is a counter in which a counter value n is changed cyclically from 1 to 12. Every time it reaches 24 o'clock on Sunday, that is, zero o'clock in the morning on Monday, the twelve-week counter 52 receives the beginning-of-week signal Sw from the beginning-of-week determination unit 51, and changes the counter value n of the absolute change-of-week signal Sw by one. The contents 1, 2, 3 . . . , n . . . , 11, and 12 of the counter 52 represent continuous twelve absolute weeks, respectively. Note that the twelve week counter 52 outputs an absolute change-of-week alarm signal Swa every time of receiving the absolute change-of-week signal Sw.

The absolute weekly number-of-step processing unit 53 includes a one-step walking data holding unit 53a, a number-of-step arithmetic operation unit 53b, and an absolute weekly number-of-step storage unit 53c.

The one-step walking data holding unit 53a, number-of-step arithmetic operation unit 53b, and absolute weekly number-of-step storage unit 53c of the absolute weekly number-of-step processing unit 53 function similarly to the one-step walking data holding unit 42a, number-of-step arithmetic operation unit 42b, and daily number-of-step storage unit 42c of the daily number-of-step processing unit 42, except that they refer to the contents n of the twelve-week counter 52 in place of the contents i of the seven-day counter 41, operate upon receiving the absolute change-of-week alarm signal Swa in place of the change-of-day alarm signal Sda, and output an absolute weekly number-of-step arithmetic operation completion signal GW1 in place of the daily number-of-step arithmetic operation completion signal GD1.

Specifically, the absolute weekly number-of-step storage unit 53c holds the absolute weekly number of steps WDn(1) for twelve weeks in the absolute weekly number-of-step storage area RWDn(1). Every time of receiving the walking pulse F from the walking detection unit 14, the number-of-step arithmetic operation unit 53b reads out the absolute weekly number of steps WDn(1) from the absolute weekly number-of-step storage area RWDn(1) corresponding to the contents n of the twelve-week counter 52. Then, the number-of-step arithmetic operation unit 53b overwrites and stores, in the absolute weekly number-of-step storage area RWDn(1), the absolute weekly number of steps WDn(1) updated by adding the held data “1” of the one-step walking data holding unit 53a to the absolute weekly number of steps WDn(1) concerned, and further, outputs the absolute weekly number-of-step arithmetic operation completion signal GW1. Note that, upon receiving the absolute change-of-week alarm signal Swa from the twelve-week counter 52, the absolute weekly number-of-step processing unit 53 resets, to zero, the absolute weekly number of steps WDn(1) of the absolute weekly number-of-step storage area RWDn(1) corresponding to the contents n of the counter 52 at that time.

Irrespective of which day of the week the measurement is started from, the absolute weekly number-of-step processing unit 53 accumulates and counts the number of steps WDn(1) until Sunday of the week concerned as a first absolute week number of steps WD1(1), and when Monday comes, performs accumulation and counting processing for the number-of-step data of that day and after as the number-of-step data of a next absolute week. Hence, at an arbitrary point of time, the number of steps in the absolute week concerned therewith is stored as the accumulated number of steps WDn(1) of the absolute week concerned in the absolute week number-of-step storage area RWDn(1), and can be directly read and immediately displayed any time from the absolute week number-of-step storage area RWDn(1). However, if desired, the number of steps may be obtained by using the daily number of steps DDn(1) in place of directly counting the number-of-step signal F from the number-of-step detection unit 14 counting the weekly number of steps WDn(1).

The absolute weekly calorie consumption processing unit 54 includes a unit calorie consumption holding unit 54a, a calorie consumption arithmetic operation unit 54b, and an absolute weekly calorie consumption storage unit 54c.

The unit calorie consumption holding unit 54a, calorie consumption arithmetic operation unit 54b, and absolute weekly calorie consumption storage unit 54c of the absolute weekly calorie consumption processing unit 54 function similarly to the unit calorie consumption holding unit 43a, calorie consumption arithmetic operation unit 43b, and daily calorie consumption storage unit 43c of the daily calorie consumption processing unit 43, except that they refer to the contents n of the twelve-week counter 52 in place of the contents i of the seven-day counter 41, operate upon receiving the absolute weekly number-of-step arithmetic operation completion signal GW1 in place of the daily number-of-step arithmetic operation completion signal GD1, and output an absolute weekly calorie consumption arithmetic operation completion signal GW2 in place of the daily calorie consumption arithmetic operation completion signal GD2. Also in the absolute daily calorie consumption arithmetic operation unit 54b, the processing may be started in response to the walking signal F in place of the absolute weekly number-of-step arithmetic operation completion signal GW1.

The absolute weekly walking distance processing unit 55 includes a stride length holding unit 55a, a walking distance arithmetic operation unit 55b, and an absolute weekly walking distance storage unit 55c.

The stride holding unit 55a, walking distance arithmetic operation unit 55b, and absolute weekly walking distance storage unit 55c of the absolute weekly walking distance processing unit 55 function similarly to the unit walking distance holding unit 44a, walking distance arithmetic operation unit 44b, and daily walking distance storage unit 44c of the daily walking distance processing unit 44, except that they refer to the contents n of the twelve-week counter 52 in place of the contents i of the seven-day counter 41, operate upon receiving the absolute weekly calorie consumption arithmetic operation completion signal GW2 in place of the daily calorie consumption arithmetic operation completion signal GD3, and output an absolute weekly walking distance arithmetic operation completion signal GW3 in place of the daily walking distance arithmetic operation completion signal GD3. Also in the absolute daily walking distance arithmetic operation unit 55b, the processing may be started in response to the walking signal F in place of the absolute weekly calorie consumption arithmetic operation completion signal GW2.

The absolute weekly walking time processing unit 56 includes a unit time data holding unit 56a, a walking time arithmetic operation unit 56b, and an absolute walking time storage unit storage unit 56c.

The unit time data holding unit 56a, walking time arithmetic operation unit 56b, and absolute walking time storage unit storage unit 56c of the absolute weekly walking time processing unit 56 function similarly to the unit time data holding unit 45a, a walking distance arithmetic operation unit 45b, and daily walking distance storage unit 45c of the daily walking distance processing unit 45, except that they refer to the contents n of the twelve-week counter 52 in place of the contents i of the seven-day counter 41 and operate upon receiving the absolute weekly walking distance operation completion signal GW3 in place of the daily walking distance arithmetic operation completion signal GD3. Also in the absolute weekly walking time arithmetic operation unit 56b, the processing may be started in response to the walking signal F in place of the absolute weekly walking distance arithmetic operation completion signal GW3. The walking time arithmetic operation unit 56b may be configured to be directly count the clock signal in the same manner as the walking distance arithmetic operation unit 45b.

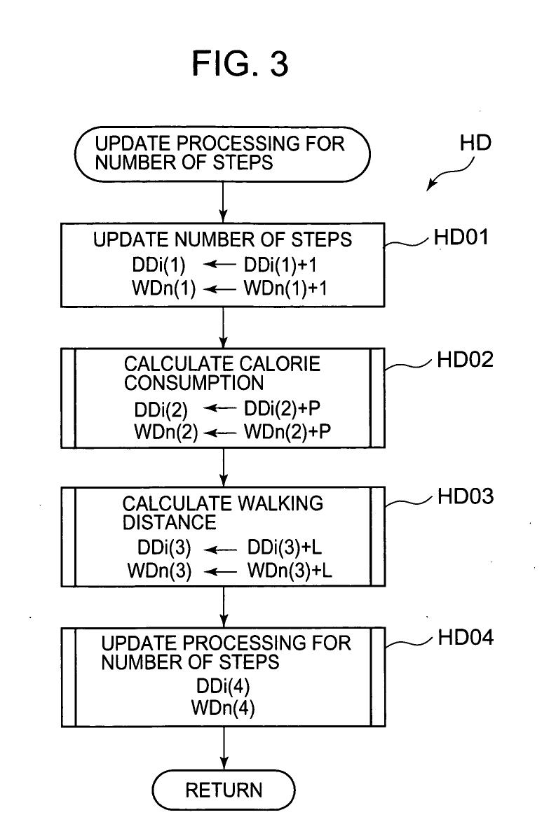

Note that, in the above, the description has been made as if the processing for the daily data and the processing for the absolute weekly data were performed separately; however, the order of arithmetic operation on the various data (number of steps, calorie consumption, walking distance, walking time, and the like) of the daily data and the similar data of the absolute weekly data can be made different from one another as desired. Specifically, as shown next in a flowchart of FIG. 3, for example, after the arithmetic operation processing for the daily and absolute weekly number of steps is performed, the arithmetic operation processing for the daily and absolute weekly calorie consumptions is performed, and next, the arithmetic operations for the daily and absolute weekly walking distances and the arithmetic operations for the daily and absolute weekly walking times are performed. As such, the arithmetic operation orders are changeable as desired. However, for example, as in the case of performing the arithmetic operation of the average walking speed, in the case of utilizing other data (for example, walking distance and walking time), the arithmetic operations for the data to be utilized are performed in advance according to needs.

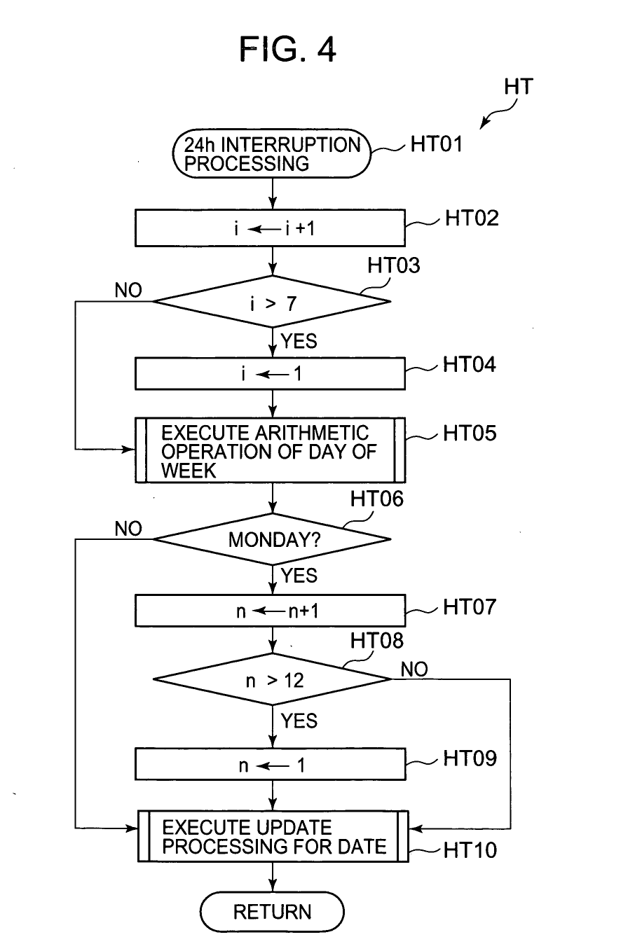

Next, a measurement operation of the pedometer 1 configured as described above will be described based on a flowchart from a viewpoint closer to flows of processing of the programs of FIG. 3 and FIG. 4.

In the case of counting/storing the daily data and the absolute weekly data in the pedometer 1, operations of the seven-day counter 41, the beginning-of-week determination unit 51, and the twelve-week counter 52, which are based on the timepiece data of the timer unit 31, will be described based on a flowchart HT of FIG. 4.

For example, in the pedometer 1, every time it reaches 24 o clock (zero o'clock in the morning), every 24-hour interruption processing is performed (Step HT01 of FIG. 4). This corresponds to that the seven-day counter 41 receives the change-of-day signal Sd from the timer unit 31. In the every 24-hour interruption processing, in the seven-day counter 41, “1” is added to the contents i of the counter 41, and “i+1” is obtained (Step HT02). The contents i of the seven-day counter 41 correspond to the storage area RDDi(k) of the daily data DDi(k), that is, a memory address to be referred to in recording the daily data DDi(k). Next, it is determined whether or not “i+1” exceeds “7” (Step HT03). When “i+1” exceeds “7”, the contents i of the counter 41 are returned to “1” (Step HT04). Specifically, when the measuring period exceeds seven days, control is made so as to return the memory address of the day data to the head thereof, and to overwrite the day data into an original data area thereof. Hence, it becomes impossible to refer to the daily data of more than seven days before. Meanwhile, when “i+1” is “7” or less, the processing enters the arithmetic operation processing for the day of the week while the contents of “i+1” are being left held as new contents i in the seven-day counter 41 (Step HT05). Here, Steps HT02 to HT04 correspond to the operations of the seven-day counter 41.

When the processing enters the arithmetic operation of the day of the week (Step HT05), first, it is determined by the beginning-of-week determination unit 51 whether or not the new day is Monday based on the year/month/day data YMD from the timer unit 31 (Step HT06). When the new day is other day than Monday, the processing returns to update processing for date (Step HT10), and the every 24-hour interruption processing is awaited (Step HT01).

When the new day is Monday (which corresponds to that the beginning-of-week signal Sw is outputted from the beginning-of-week determination unit 51), “1” is added to the contents n of the counter 52 for the purpose of updating the contents of the twelve-week counter 52, and “n+1” is obtained (Step HT07). Specifically, the variable n which modifies the memory address of the week data is increased by 1. Next, it is determined whether or not “n+1” exceeds “12” (Step HT08). When “n+1” exceeds 12; the contents n of the counter 41 are returned to “1” (Step HT09). Specifically, when the measuring period exceeds twelve weeks, control is made so as to return the memory address of the absolute week data to the head thereof, and to overwrite the absolute week data into an original data area thereof. Hence, it becomes impossible to refer to the absolute weekly data of more than twelve weeks before. Meanwhile, when “n+1” is “12” or less, the processing returns to the update processing for the date while the contents of “n+1” are being left held as new contents n in the twelve-week counter 52 (Step HT10). Here, Steps HT07 to HT09 correspond to the operations of the twelve-week counter 52.

The pedometer 1 counts and stores the various data every time of detecting a new walking signal F as shown in the flowchart HD of FIG. 3.

For example, first, update processing of the number of steps is performed (Step HD01 of FIG. 3). In this number-of-step update processing step HD01, the daily number of steps DDi(1) is obtained while making a definition as: DDi(1)=DDi(1)+1, and the absolute weekly number of steps DDi(1) is obtained while making a definition as WDn(1)=WDn(1)+1. In the block diagram of FIG. 7, these pieces of processing correspond to the arithmetic operation/storage processing for the daily number of steps DDi(1) performed by the daily number-of-step processing unit 42, and to the arithmetic operation/storage processing for the absolute weekly number of steps WDn(1) performed by the absolute weekly number-of-step processing unit 53.

Next, update processing of the calorie consumption is performed (Step HD02 of FIG. 3) In this calorie consumption update processing step HD02, the daily calorie consumption DDi(2) is obtained while making a definition as: DDi(2)=DDi(2)+P, and the absolute weekly calorie consumption DDi(2) is obtained while making a definition as WDn(2)=WDn(2)+P. In the block diagram of FIG. 7, these pieces of processing correspond to the arithmetic operation/storage processing for the daily calorie consumption DDi(2) performed by the daily calorie consumption processing unit 43, and to the arithmetic operation/storage processing for the absolute weekly calorie consumption WDn(2) performed by the absolute weekly calorie consumption processing unit 54.

Further, update processing of the walking distance is performed (Step HD03 of FIG. 3). In this walking distance update processing step HD03, the daily walking distance DDi(3) is obtained while making a definition as: DDi(3)=DDi(3)+L, and the absolute weekly walking distance DDi(3) is obtained while making a definition as WDn(3)=WDn(3)+L. In the block diagram of FIG. 7, these pieces of processing correspond to the arithmetic operation/storage processing for the daily walking distance DDi(3) performed by the daily walking distance processing unit 44, and to the arithmetic operation/storage processing for the absolute weekly walking distance WDn(3) performed by the absolute weekly walking distance processing unit 55.

Next, update processing for the walking time is performed (Step HD04 of FIG. 3). In this walking time update processing step HD04, the daily walking time DDi(4) is obtained while making a definition as: DDi(4)=DDi(4)+Δts, and the absolute weekly walking time DDi(4) is obtained while making a definition as WDn(4)=WDn(4)+Δts. In the block diagram of FIG. 7, these pieces of processing correspond to the arithmetic operation/storage processing for the daily walking time DDi(4) performed by the daily walking time processing unit 45, and to the arithmetic operation/storage processing for the absolute weekly walking time WDn(4) performed by the absolute weekly walking time processing unit 56. Here, it is as described above that, as the walking time, the number of daily and absolute weekly clock signals during the walking may be counted.

The display of the display unit 15 of the pedometer 1 is performed by the display control unit 25 (FIG. 7). The operation of the display control unit 25 is controlled by contents “k” of the data type counter 28 in addition to contents “j” and “m” of the display date counter 47 and the display (absolute) week counter 57. The data type counter 28 may be provided separately for the daily data and the absolute weekly data, or may be shared therebetween. As the hardware, the display control unit 25 includes the CPU 11, and the ROM 18a, which stores the program executed by the CPU concerned, in addition to the display drive circuit 16 of FIG. 1.

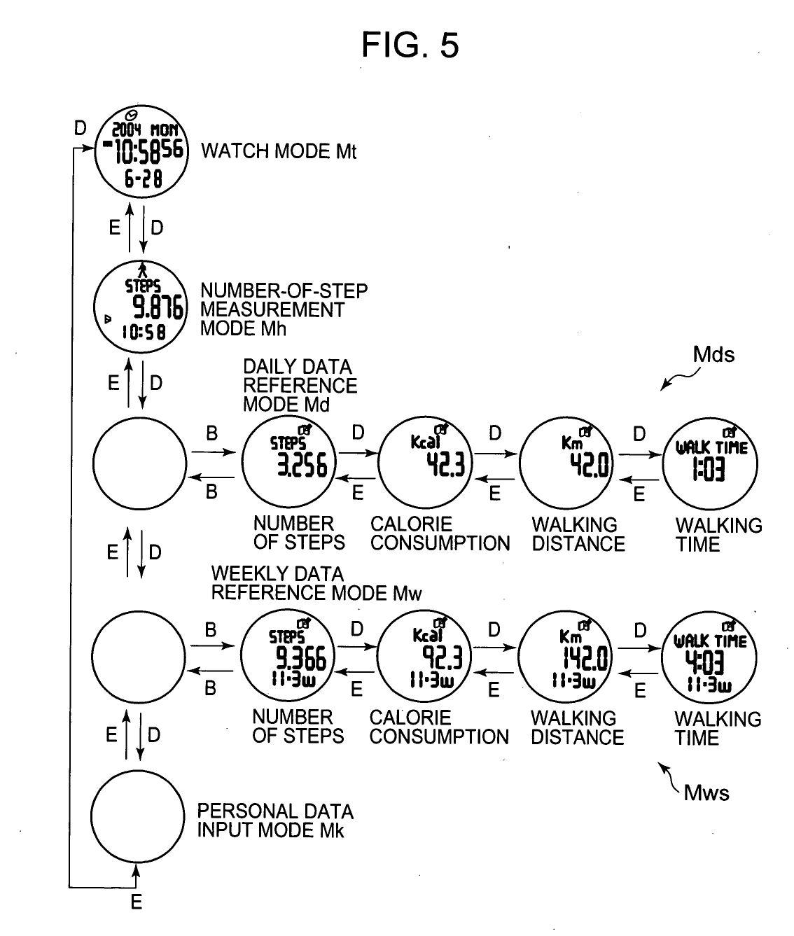

An outline of the display on the pedometer 1 is shown in FIG. 5. As seen from FIG. 5, in the pedometer 1, there are five display modes, which are: a timepiece mode Mt; a number-of-step measurement mode (mode of directly displaying the number of steps under measurement) Mh; a day data reference mode Md; a week data reference mode Mw; and a personal data input mode Mk. By rotating the rotary switch 13d in the D direction, the modes are switched cyclically as Mt→Mh♯Md→Mw→Mk→Mt. By rotating the rotary switch 13d in the E direction, the modes are switched cyclically as Mt→Mk→Mw→Md→Md→Mh→Mt.

Note that, as shown in FIG. 6, a display screen of the display unit 15 includes a mark display portion 15a which displays a mode type, a comment display portion 15b performing dot display, a main data display portion 15c, an auxiliary data display portion 15d, and the like. The mode type mark display portion 15a includes a timepiece mark 15a1 switched on and displayed in the case of the timepiece mode Mt, a walking mark 15a2 switched on and displayed in the case of the number-of-step measurement mode Mh, and a recording book or notebook mark 15a3 switched on in the case of the display of the daily data and the absolute weekly data.

In the timepiece mode Mt, the pedometer 1 is usable as the timepiece, and time information is displayed by the display unit 15. In this example, as seen from FIG. 5, the hour, the minute, and the second are displayed by the main data display portion 15c, the year and the day of the week are displayed on the comment display portion 15b, and the month and the date are displayed by the auxiliary data display portion. As a matter of course, a way of the display may differ from this.

In the number-of-step measurement mode Mh, the pedometer 1 is usable as the pedometer, and information on the number of steps is displayed by the display unit 15. In this example, as shown in FIG. 5, the walking mark 15a2 is switched on in the mark portion 15a, the number of steps in that day is displayed on the main data display portion 15c, the effect that the number of steps is being displayed is displayed as “STEPS” on the comment display portion 15b, and the time display of the hour and the minute is made by the auxiliary data display portion. Away of the display may differ from this.

In the day data reference mode Md, it is possible to refer to the daily data. By pushing the push-button switch 13b in the B direction for a predetermined time (for example, approximately two seconds) or more, the state is switched to a state Mds capable of displaying the daily data. By rotating the rotary switch 13d in the D direction in the state Mds, the display is sequentially switched as: the daily number of steps DDj(1)→the daily calorie consumption DDj(2)→the daily walking distance DDj(3)→the daily walking time DDj(4). By rotating the rotary switch 13d in the E direction, the display is sequentially switched as: the daily walking time DDj(4)→the daily walking distance DDj(3)→the daily calorie consumption DDj(2)→the daily number of steps DDj(1). By pushing the push-button switch 13b in the B direction for the predetermined time (for example, approximately two seconds) or more in the state Mds, the state returns from the state Mds to a basic state capable of switching the display to other modes. Note that, in the state Mds, “j” represents the contents of the display date counter 47, and an initial value thereof is set as j=1 by referring to the contents “i” of the seven-day counter 41. Further, in the state Mds where the daily data DDj(k) is displayed, “j” is decremented by 1 every time the push-button switch 13c is pushed in the C direction, and the daily data DDj(k) returned day by day is displayable. In DDj(k), “k” represents the above-described data type.

In the day data display state Mds in the day data reference mode Md, the recording book mark 15a3 is switched on in the mark portion 15a, the respective pieces of data is displayed on the main data display portion 15c, and the unit and the comment which represent the data type are displayed on the comment portion 15b.

The same as above is also applied to the absolute weekly data. In the absolute weekly data reference mode Mw, it is possible to refer to the absolute weekly data. By pushing the push-button switch 13b in the B direction, the state is switched to a state Mws capable of displaying the absolute weekly data. By rotating the rotary switch 13d in the D direction in the state Mws, the display is sequentially switched as: the absolute weekly number of steps WDm(1)→the absolute weekly calorie consumption WDm(2)→the absolute weekly walking distance WDm(3)→the absolute weekly walking time WDm(4). By rotating the rotary switch 13d in the E direction, the display is sequentially switched as: the absolute weekly walking time WDm(4)→the absolute weekly walking distance WDm(3)→the absolute weekly calorie consumption WDm(2)→the absolute weekly number of steps WDm(1). By pushing the push-button switch 13b in the B direction for the predetermined time (for example, approximately two seconds) or more in the state Mws, the state returns from the state Mws to the basic state capable of switching the display to other modes. Here, “m” represents the contents of the display week counter 57, and an initial value thereof is set as m=n by referring to the contents “n” of the twelve-week counter 52. Further, in the state where the absolute weekly data WDm(k) is displayed, “m” is decremented by 1 every time the push-button switch 13c is pushed in the C direction, and the absolute weekly data WDm(k) returned day by day is displayable.

In the absolute weekly data display state Mws in the week data reference mode Mw, the recording book mark 15a3 is switched on in the mark portion 15a, the respective pieces of data is displayed on the main data display portion 15c, and the unit and the comment which represent the data type are displayed on the comment portion 15b. Further, in the absolute weekly data display state Mws, the order of weeks of a month the absolute week concerned comes and which month the month concerned is are displayed on the auxiliary data display portion 15d located at the lower stage. In the example of FIG. 5, it is shown that the data is one in the third week of November. The reason why the display as described above is possible is that the counting is performed not by taking, as a reference, the day when the measurement starts, but by taking the absolute week as the reference.

A description will be briefly made of, as an example, the case of starting the count of the number of steps from Wednesday in the pedometer 1 configured as described above. In response to an instruction to start the use, the daily data DDi(k) of the daily data storage area RDDi(k) and the absolute weekly data WDn(k) of the absolute weekly data storage area RWDn(k) are entirely reset to zero.

During a period until 24 o'clock on Wednesday since the count for the number of steps was started, the number-of-step data DD1(1) is sequentially updated in response to the walking signal F. In a similar way, the calorie consumption DD1(2), the walking distance DD1(3), and the walking time DD1(4) are also updated sequentially.

When the mode enters the day data reference mode Md by rotating the mode switch 13d in the D or E direction, and when the mode is switched to the data reference mode Mds by depressing the push-button switch 13d in the B direction for the predetermined time or more, the number-of-step data DD1(1) obtained from zero o'clock until the current time is displayed. When the rotary switch 13d is rotated in the D direction in the state Mds, the calorie consumption DD1(2) obtained until the current time of that day is displayed. When the switch 13d is further rotated in the D direction, the walking distance DD1(3) and the walking time DD1(4) are displayed.

When the mode switch 13d is further rotated in the D direction after the state returns to the mode changing state by the switch 13b, the mode enters the absolute weekly data display mode Mw. When the push-button switch 13d is pressed in the B direction for the predetermined time or more in the mode Mw to thereby switch the state to the data reference state Mws, the absolute weekly data is displayed. In this case, because the day is not updated yet because the data has just started to be collected, the absolute weekly data and the daily data are the same, and relations are established as: the number of steps WD1(1)=DD1(1); the calorie consumption WD1(2)=DD1(2); the walking distance WD1(3)=DD1(3); and the walking time WD1(4)=DD1(4).

When it is 24 o'clock, the processing enters the processing for updating the date, the contents i of the seven-day counter 41, that is, the address modifying data i for the day data is updated from 1 to 2, the reference area of the daily data is updated from RDD1(k) to RDD2(k), and the daily data to be referred to is updated from DD1(k) to DD2(k). Meanwhile, since the new current day is not Monday but Thursday, the contents n of the twelve-week counter 52, that is, the address modifying data n=1 for the absolute weekly data is not updated, the reference area of the absolute weekly data is maintained at RWD1(k) without being updated, and the absolute weekly data to be referred to is maintained at WD1(k). Hence, the number of steps WD1(1), the calorie consumption WD1(2), the walking distance WD1(3), and the walking time WD1(4) are accumulated and added from the day before, as the absolute weekly data WD1(k). Hence, when the daily data DD2(k) is referred to on Thursday, the daily data of Thursday is displayed, and when the absolute weekly data WD1(k) is referred to, the accumulated data from Thursday is displayed.

When it is 24 o'clock on Monday (zero o'clock in the morning on Monday), not only the address modifying data i (contents 1 of the seven-day counter 41) for the daily data is updated from 5 to 6, but also the address modifying data n (contents n of the twelve-week counter 52) for the absolute weekly data is updated from 1 to 2. In such a way, the accumulated data from Wednesday until Sunday is recorded/stored in the WD1(k), and the data from Monday is newly accumulated in the WD2(k).

Under the data reference state Mds in the daily data reference mode Md, which follows the data accumulation performed for a considerable number of days as described above, the number of steps DDi(1) at the current day is displayed. By rotating the rotary switch 13d in the D direction or the E direction, the number of steps DDi(1), the calorie consumption DD1(2), the walking distance DDi(3), and the walking time DDi(4) are displayed.

Every time the push-button switch 13c is pressed in the C direction in the state Mds, the data of one day before is displayed. When the push-button switch 13c is pressed in the C direction in a state where the data of six days before is displayed, the display returns to the data display of the current day. Note that, as regards the display, the contents j of the display date counter 47 are changed by pressing the push-button switch 13c in the C direction. The display date counter 47 captures the contents i of the seven-day counter 41 as an initial value of j, and displays the data of the day corresponding thereto. Meanwhile, one pressing of the push-button switch 13c in the C direction decreases the contents j of the display date counter 47 by one. Here, similarly to i, j is the address for modifying data, indicates the memory address in the RAM in which the address is modified, and designates the daily data as DDj(k).

The same as above is also applied to the absolute weekly data. Under the data reference state Mws in the absolute weekly data reference mode Mw, the accumulated number-of-step data WDn(1) of the week (from Monday until the current day) is displayed. By rotating the rotary switch 13d in the D direction or the E direction, the number of steps WDn(1), the calorie consumption WDn(2), the walking distance WDn(3), and the walking time WDn(4) are displayed.

Every time the push-button switch 13c is pressed in the C direction, the data of one week before is displayed. When the push-button switch 13c is pressed in the C direction in a state where the data of eleven weeks before is displayed, the display returns to the data display of the current week. Also in this case, as regards the display, the pressing of the push-button switch 13c in the C direction changes the contents m of the display week counter 57. The display week counter 57 captures the contents n of the twelve-week counter 52 as an initial value of m, and displays the data of the current week corresponding thereto. Meanwhile, one pressing of the push-button switch 13c in the C direction decreases the contents m of the display week counter 57 by one. Here, similarly to n, m is the address for modifying data, indicates the memory address in the RAM in which the address is modified, and designates the absolute weekly data as DDm(k).

Note that, in the above, the description has been made of an example of counting the absolute weekly data with regard to the weekly data; however, it is also possible to apply a similar case to month data. Specifically, there may be provided: a daily event-quantity counter unit which daily counts the event quantity; an absolute monthly event-quantity counter unit which counts the event quantity every month defined by a period between a specific day of a month and a day before the specific day of the next month; and an absolute monthly event-quantity storage unit which stores the absolute monthly event quantity over a plurality of the absolute months, to thereby count the event quantity.

Further, in this embodiment, a configuration has been adopted, in which the number of event signals outputted from the event detection unit is sequentially counted with regard to the week data; however, a configuration may also be adopted, in which the week data is updated by using the data of the daily number-of-step counter unit only at the time when the day changes.

What is claimed is:

1. A portable event-quantity measuring instrument comprising:
an event detection unit which senses an event and outputs an event signal;
event-quantity counting means for counting the event signal outputted from the event detection unit and counting an event quantity, the event-quantity counting means including a daily event-quantity counter unit which daily counts the event quantity, and an absolute weekly event-quantity counter unit which counts the event quantity every absolute week defined from a specific day of a week until a day before the specific day of the next week; and
event-quantity storing means for readably storing the counted event quantity, the event-quantity storing means including a daily event-quantity storage unit which stores daily event quantities over plural days, and an absolute weekly event-quantity storage unit which stores absolute weekly event quantities over plural absolute weeks.

2. A portable event-quantity measuring instrument according to claim 1, wherein the daily event-quantity counter unit is configured to count a number of the event signals outputted from the event detection unit, and to daily count the event quantities, and the absolute weekly event-quantity counter unit is configured to count the number of event signals outputted from the event detection unit, and to count the event quantities every absolute week.

3. A portable event-quantity measuring instrument according to claim 1, wherein the portable event-quantity measuring instrument is configured to be worn on a wrist.

4. A portable event-quantity measuring instrument according to claim 1, wherein the event is walking, the event signal is a walking signal, and the event quantity includes at least one quantity selected from the group consisting of a number of steps, a calorie consumption, a walking distance, and a walking time.

5. A pedometer, comprising:
a walking sensor which senses walking and outputs a walking signal;
number-of-step counting means for counting a number of the walking signals from the walking sensor and counting a number of steps, the number-of-step counting means including a daily number-of-step counter unit which daily counts the number of steps, and an absolute weekly number-of-step counter unit which counts the number of steps every absolute week defined from a specific day of a week until a day before the specific day of the next week; and
number-of-step storing means for readably storing the counted number of steps, the number-of-step storing means including a daily number-of-step storage unit which stores a daily number of steps over plural days, and an absolute weekly number-of-step storage unit which stores an absolute weekly number of steps over plural absolute weeks.

6. A pedometer according to claim 5, wherein the daily number-of-step counter unit is configured to count a number of the walking signals from the walking sensor, and to daily count the number of steps, and the absolute weekly number-of-step counter unit is configured to count the number of walking signals from the walking sensor, and to count the number of steps every absolute week.
